(19) United States
(12) Patent Application Publication
(10) Pub. No.: US 2010/0320940 A1
(43) Pub. Date: Dec. 23, 2010

(54) Monitoring Device and Method of Monitoring Programmable Lamps

(76) Inventors: Markus Salm, Heusweiler (DE); Udo Kuenzler, Karlsbad (DE)

Correspondence Address: GLENN PATENT GROUP, 3475 EDISON WAY, SUITE L, MENLO PARK, CA, 94025, US

(21) Appl. No.: 12/739,368

(22) PCT Filed: Oct. 24, 2008
(86) PCT No.: PCT/EP2008/009038

§ 371 Date: Sep. 2, 2010

(30) Foreign Application Priority Data
Oct. 25, 2007 (DE) 10 2007 051 143.6

(51) Int. Cl. H05B 37/02

(52) U.S. Cl. 315/312

(57) ABSTRACT

A monitoring device for programmable lamps (10) includes an input (17) for receiving control data (11) from a first programmable lamp, an output (18) for forwarding the control data (12) to a second programmable lamp, reading means (19) for reading the control data (13) and a interface (20) for transmitting the read control data (14). In further embodiments, the wireless interface is formed in such a manner as to receive configuration, reference and test data, with which the monitoring device can be placed into the recording mode, diagnostic mode and test mode. A configurator configurates input, output, reading means and wireless interface in dependence on the configuration data received.

The present invention relates to monitoring and error diagnosis of programmable lamps or luminaires, and particularly of programmable lamps capable of being employed in the stage and event area.

DE 102004007057 discloses a concept for transmitting a DMX-512 signal for controlling luminaires. In particular, a DMX signal is generated in a control panel at a first location and compressed via a transmission modem and modulated onto the usual current supply signal. The compressed DMX signal then is transmitted to an illumination system at a remote location via the normal current supply network. There, a reception modem is provided, extracting the DMX signal and thus controlling an illumination system. Alternatively, the transmission from the control panel at the first location to the illumination system at the second location may take place in wireless manner, such that a radio transmission modem is provided at the control panel, and that a radio reception modem is provided at the remote location at which the illumination system is arranged. In particular, signals for controlling the color of the luminaire, or signals for pivoting and/or rotating (PAN/TILT) are transmitted to the luminaire in order to activate one or more motors based on these signals so as to direct the spot of the luminaire to a desired location.

Luminaires in the event area or stage lighting sector, in particular, often are assembled, disassembled, and reassembled at another location. Moreover, modern intelligent programmable lamps have high functionality and, depending on the design, high prices. On the other hand, an organizer does not necessarily need to own a great number of programmable lamps. Instead, there is an increasing number of rental service providers renting out programmable lamps from event to event, depending on demand.

This leads to the fact that it can no longer be assumed that a lamp, once it has been assembled, always remains at this location. Instead, the exact opposite increasingly becomes reality, namely that a lamp is assembled at one location, then an event takes place, e.g. for one or more days or weeks, and then the lamp is disassembled again, transported to another location and reassembled for another event there.

On the other hand, many intelligent devices used in the stage illumination sector have the possibility of being addressed with the aid of serial data protocols in order to be able to transmit the many control signals, for example regarding the brightness, the color, the direction of the spot, etc., to the lamp.

In particular, here a data line is drawn through from the control panel to the first device, then on to the second device, then on to the third device, etc. For this to work, the individual devices must be assigned a data address, such that each device extracts the part of the data protocol and/or the channel containing the data intended for the corresponding device.

The presently most common, and unfortunately also most error-prone, data protocol is DMX-512. It is based on the RS-485 standard, which is why the interface packages developed with respect thereto can be used as well. 512 useful data with 8 bits width each are transmitted. Handshaking is not provided. The transmission device transmits an accurately defined start sequence, and then a maximum of 512 bytes, with increasing channel numbers. Thereafter, the data packet starts again. The receivers are only capable of receiving. Feedback to the transmitter does not take place. The receivers are assigned start addressed beginning from which they read their required channel numbers in the data stream. Other data are ignored. The data cable is drawn from one device to the next one and is provided with a terminating resistor against wave reflections at the end (after a maximum of 32 devices).

The problem occurring many times in practice now consists in the fact that there indeed are wave reflections. The reasons may be a missing terminating resistor, bad or defective cables or scatterings from other cables or switching power supply units. Since the transmitter does not get any feedback, this can only be recognized from the fact that devices no longer react correctly, even though they seem to be in order. These errors may occur sporadically and migrate within the strand, whereby partly lengthy troubleshooting becomes necessary. To aggravate the situation, the devices partly are mounted on the ceiling or at great heights, sometimes above a lake or swimming pool or the like. This means that it will not be easy to make changes on devices once mounted.

In a typical configuration, the transmission panel is on the ground, and the programmable lamps are on the ceiling. The transmission panel sends a DMX signal into the first programmable lamp, this in turn sends the signal on to a second programmable lamp, which in turn sends the signal on to a third programmable lamp, etc. The problem now occurring is the following:

The first device still receives the correct data stream. The second device also receives the correct data stream. But the third or following devices may now experience an error due to line reflections, so that the third device does no longer receive the correct data stream. There develops a data problem, which may make itself noticeable in a malfunction. Yet troubleshooting is not possible from the ground.

In such a case, a technician must undo the data connection on location with a handheld analysis device and can read the values of the data packet on the display of the tester. Yet this is only possible for the technician by using a ladder and going to the site of the malfunction. In general, however, it cannot be expected of network technicians to be able to climb around below the ceiling, i.e. to be unafraid of heights, and at the same time operate the error analysis device at this location. The assembly crew (the so-called riggers), however, cannot perform error analysis, since they do not have the technical skills required. Moreover, apart from the technician on the ladder, a further technician is required to operate the light control device for controlling the chain of programmable lamps on the ground. Most test devices do not forward the useful signal, but only derive same for testing. This may lead to the error may not being recognized at all during the test process. In any case, communication between technician at the light control device and technician on the ladder at the error site is necessary. This either calls for a radiotelephony connection or a short distance between the two, so that communication by shouting or by corresponding hand signs is possible.

A second possibility of error analysis consists in attaching a long cable at the error site and guiding same back to the ground. Then, the operator of the light control device himself or herself may check whether the received data matches the transmitted data. This comparison, however, still has to be done manually, i.e. by reading and comparing, in the analysis devices common in the market.

A further problem is that the long, additionally fitted cable can change the wave resistance of the line chain such that an error may no longer occur or occurs at another location in the line chain.

It is the object of the present invention to provide a more convenient and more accurate measurement concept for programmable lamps.

This object is achieved by a monitoring device for programmable lamps according to claim 1 or by a method of monitoring a programmable lamp according to claim 22.

The monitoring device includes an input for receiving control data from a first controllable lamp or luminaire, an output for forwarding the control data to a second controllable lamp, reading means for reading the control data received from the input, and a wireless interface for transmitting the control data read by the reading means or data derived from the read control data.

The monitoring device may be attached at an arbitrary location in a chain of programmable lamps and measure the applying control data there. It does not interrupt the control data chain, since the control data received at the input are immediately forwarded in unchanged manner to the output, and the recording process works with a copy of the control data, without changing the original control data. In contrast to usual test methods, in which the line at the measurement site is undone, it is possible, with the method according to the invention, to perform uninterrupted, and hence undisturbed, measurement.

The read control data are forwarded from the reading means to a wireless interface and wirelessly transferred therefrom to a second location (for example to a network technician on the ground), so that the location of measuring the control data and the location of the analysis of the control data may be different. By means of this method, it is no longer necessary to lay a long cable from the location of the measurement to the location of the data analysis, which is common with test devices presently available. Hence, the construction crew (the riggers) may install the monitoring device according to the invention together with the programmable lamps upon assembly on location, generally below the ceiling at great height, and the network technician may analyze the measured control data conveniently from the ground and recognize erratic behavior. The network technician no longer has to go through the arduous task of going to the site and searching for an error there. He does not have to be unafraid of heights, since all necessary data for error analysis are sent to him wirelessly by means of the method according to the invention. The monitoring device may be built to be very compact and lightweight, since it does not require any further complex modules apart from the above-mentioned four units.

A further advantage of the invention is to be seen in the exact measurement of the control data, since there is no interference with the control data line such that line parameters change. The wireless transmission of the measured control data is electrically decoupled from the control data line, so that no interference by the measurement must be reckoned with here, as it is the case by fitting a measurement cable in presently available measuring methods. Thus, with the inventive method, it is possible to perform the measurement more accurately, since the electrical properties of the line are not changed by the measurement. As far as this is concerned, an existing malfunction can be found more quickly, which saves time and cost for the organizer.

Preferred embodiments of the present invention will be explained in greater detail in the following with reference to the accompanying drawings, in which:

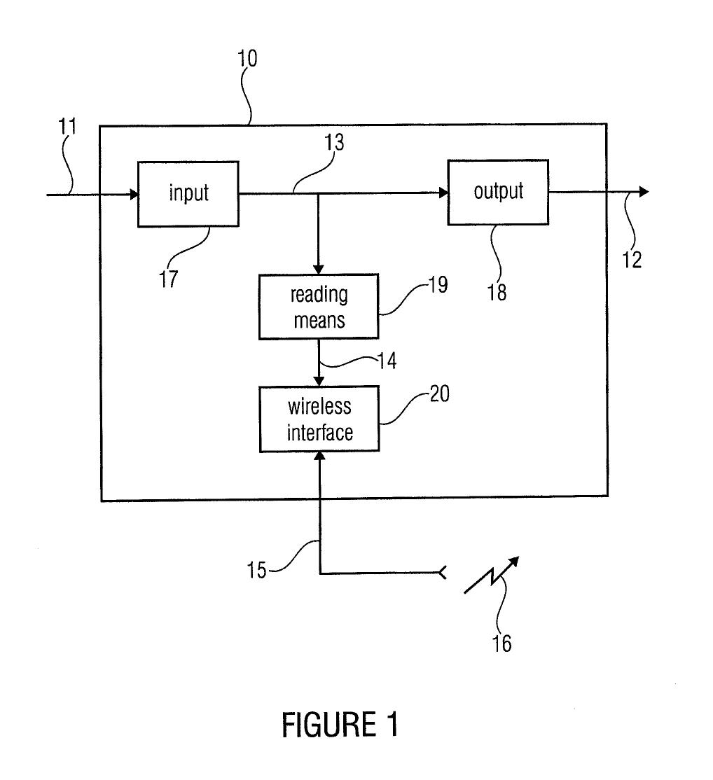

FIG. 1 shows a monitoring device for programmable lamps;

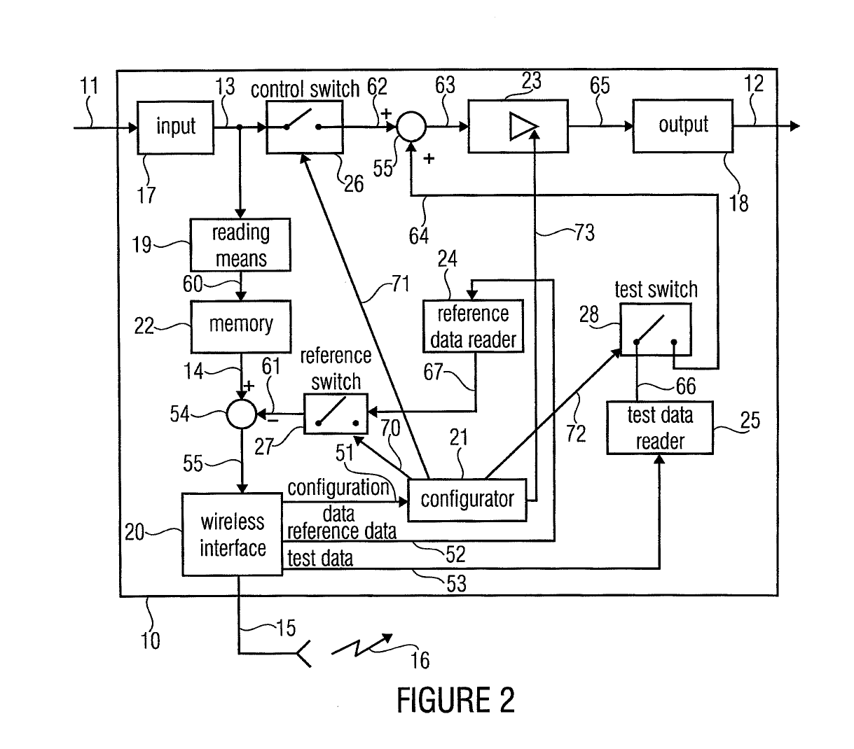

FIG. 2 shows a configurable monitoring device for programmable lamps, which can be set to the configurations of “recording mode”, “diagnostic mode” and “test mode”;

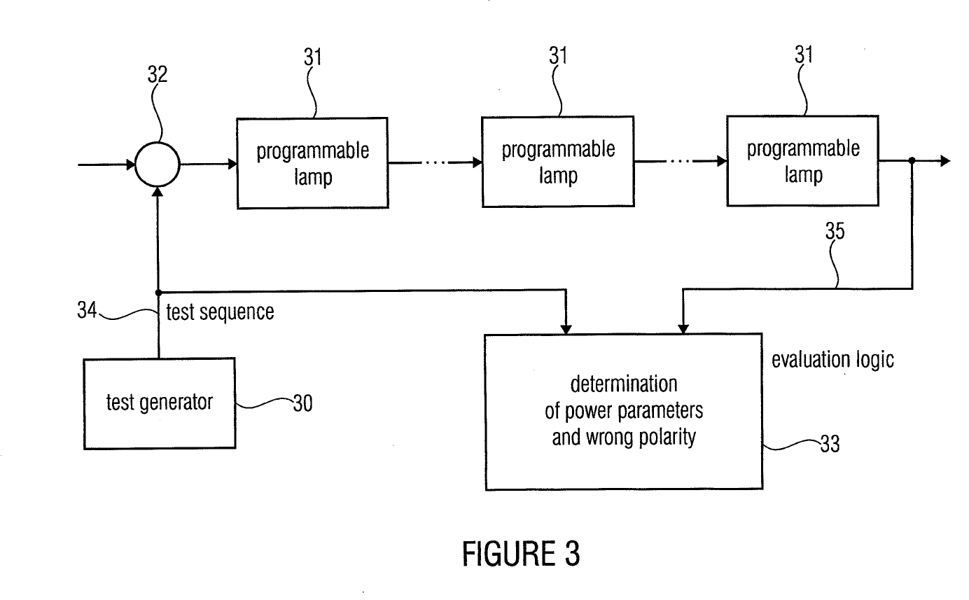

FIG. 3 shows a cable test method for a programmable lamp or a chain of programmable lamps;

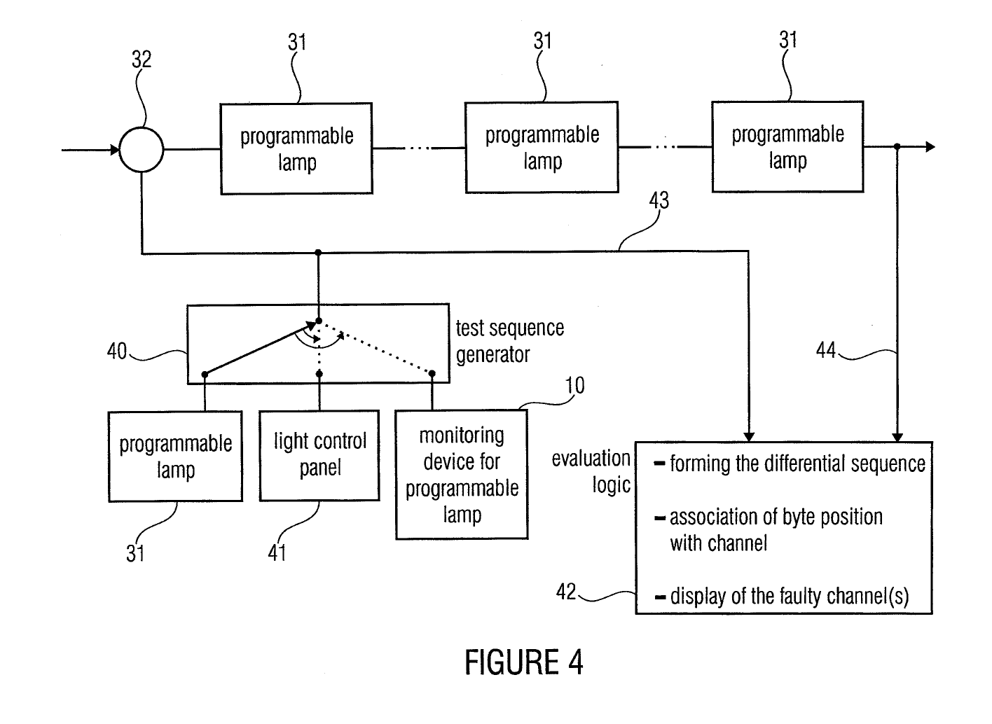

FIG. 4 shows a test and diagnosis method for programmable lamps; and

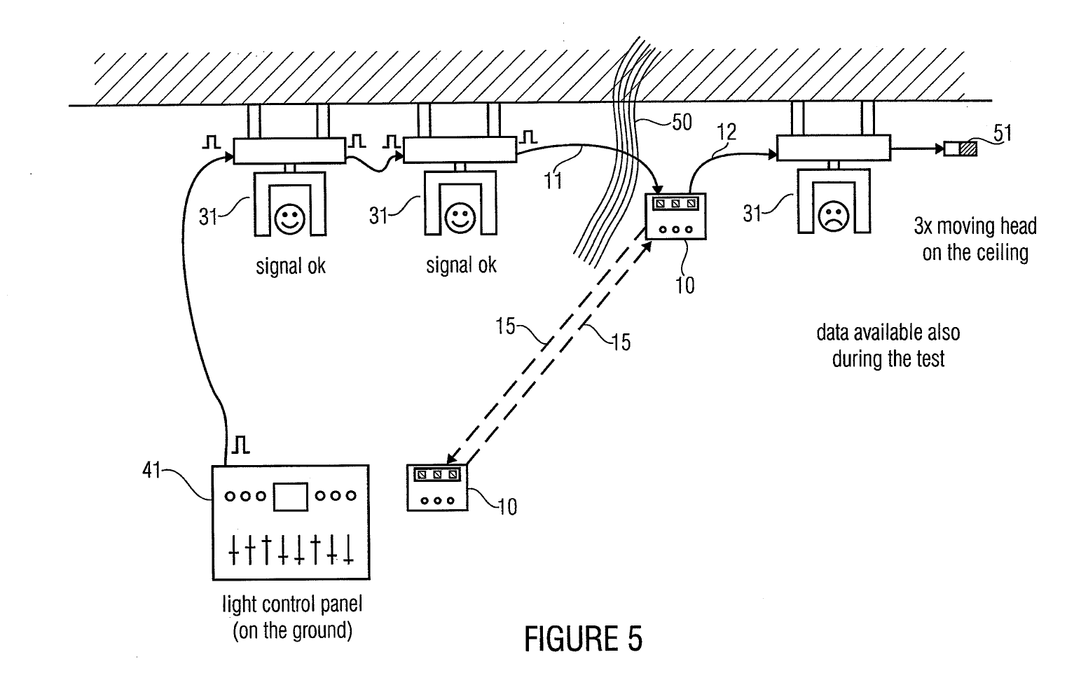

FIG. 5 shows an embodiment of a monitoring device for programmable lamps.

FIG. 1 shows a monitoring device 10 for programmable lamps or luminaires. According to the invention, it includes an input 17 for receiving control data 11 from a first controllable lamp, an output 18 for forwarding the control data 12 to a second controllable lamp, reading means 19 for reading the control data 13 received at the input, and a wireless interface 20 for transmitting the control data read from the reading means or data derived from the read control data 14.

The input 17 is directly connected to the output 18, the connection line 13 between input 17 and output 18 has a branch, so that the input 17 is connected to the reading means 19. The reading means 19 has an output 14, which is connected to the wireless interface 20. The output 15 of the wireless interface 20 is connected to an antenna 16.

The input 17 is formed to receive DMX signals. In a preferred embodiment, the input 17 is an XLR connecting plug or an XLR connecting socket, wherein XLR plug and XLR socket may be 5-pole or 3-pole.

The output 18 is formed to transmit DMX signals. In a preferred embodiment, the output 18 is an XLR connecting socket or an XLR connecting plug, wherein XLR socket and XLR plug may be 5-pole or 3-pole.

The connection line 13 between input 17 and output 18 is constructed as a data bus in bus topology (“daisy chain”), in a preferred embodiment. For the branch, a splitter is used, but it may also be formed as a simple T element. The reading means 19 may be a DMX receiver, in a preferred embodiment, a DMX-512 receiver in accordance with the USITT (United States Institute for Theater Technology) standard, in accordance with the DIN 56930 standard or in accordance with the ANSI E1.11 standard. In a further form, the reading means may also be a DMX-USB receiver converting DMX signals on the control line into computer-readable commands via a DMX-USB interface.

The wireless interface is embodied as WLAN (Wireless Local Area Network) transmitter in accordance with the IEEE standard 802.11, in a preferred embodiment. In further embodiments, transmitters in accordance with the ETSI HIPERLAN standard, in accordance with the HomeRF or in accordance with the WiFi radio standard for wireless networks, in accordance with the IEEE standard 802.15.1 (Bluetooth) for the wireless networking of devices over short distances, or in accordance with the DECT (Digital European Cordless Telecommunication) standard in accordance with ETSI EN300175 for cordless communication are employed. In less common embodiments, the wireless interface may also be a WiMAX transmitter in accordance with the IEEE 802.16 standard. Apart from a radio network, an infrared interface in accordance with the IrDA (Infrared Data Association) standard may also be possible as a further preferred embodiment. An antenna is employed for transmitting the wireless signal.

The wireless interface transmits the data 15 to a remote device via an air interface 16. The monitoring device according to FIG. 1 permits monitoring the control data of the programmable lamp by transmitting same to a remote party via a wireless interface.

FIG. 2 shows a configurable monitoring device 10 for programmable lamps. According to the invention, it includes an input 17 for receiving control data 11 from a first controllable lamp, an output 18 for forwarding the control data 12 to a second controllable lamp, an amplifier 23 for amplifying the control data, reading means 19 for reading the control data 13 received at the input, a memory 22 for storing the control data read by the reading means, and a wireless interface 20 for sending the control data read by the reading means or data derived from the read control data 55. The output 15 of the wireless interface 20 is connected to an antenna 16.

The wireless interface is formed to receive configuration data 51, reference data 52 and test data 53. Furthermore, the configurable monitoring device in accordance with the invention according to FIG. 2 includes the following components:

A configurator 21 for receiving the configuration data 51 from the wireless interface 20, a reference data reader 24 for reading the reference data 52 from the wireless interface 20, a test data reader 25 for reading the test data 53 from the wireless interface 20, a control switch 26 for switching on or off the control data 13 received at the input, a reference switch 27 for switching on or off the reference data 52 read at the reference data reader 24, a test switch 28 for switching on or off the test data 53 read at the test data reader 25, a subtraction unit for subtracting the reference data 61 switched by the reference switch 27 from the control data 13 stored by the memory 22 of the first controllable lamp, an addition unit 55 for adding the control data 62 switched by the control switch 26 and the test data 64 switched by the test switch 28.

The input 17 is connected to the control switch 26, with the connection line 13 having a branch between input and control switch, so that the input 17 also is connected to the reading means 19. The output of the reading means 60 is connected to the memory 22, the output data 14 of which reach the subtraction unit 54. The subtraction unit 54 subtracts the reference data 61 switched by the reference switch 27 from the control data 14 present at the output of the memory 22 and forwards said differential data 55 to the wireless interface 20. The wireless interface 20 forwards the data 15 to be sent to an antenna 16.

The configuration data 51 received from the wireless interface 20 are forwarded to a configurator 21 switching the three switches, namely control switch 26, reference switch 27 and test switch 28, on and off by means of configuration control lines 70, 71 and 72 and adjusting the amplifier 23 with an amplification configured via the configuration data 51 by means of a configuration control line 73. Switching the control switch 26 on means that the data present at the input of the control switch are connected through to the output, switching the control switch 26 off means that the data present at the input of the control switch are not connected through to the output. The same behavior applies to the reference switch and the test switch.

The reference data 52 received from the wireless interface 20 are supplied to a reference data reader 24, which passes the read reference data 67 on to the input of the reference switch 27. The test data 53 received from the wireless interface 20 are supplied to a test data reader 25, which passes the read test data 66 on to the input of the test switch 28. The test switch switches the read test data 66 to the second input 64 of the addition unit 55, at the first input 62 of which the control data 13 switched by the control switch 26 are present. The addition unit 55 adds both data sequences 62 and 64 and passes the result 63 on to the input of the amplifier 23. It amplifies the data 63 present at the output of the addition unit 55 with an amplification adjustable by the configurator 21 and forwards the now-amplified control data 65 to the output 18, from where said control data 12 proceed to a second controllable lamp.

Preferred embodiments of the input 17, the output 18, the reading device 19 and the wireless interface 20 as well as the branch line 13 are shown in FIG. 1. The memory 22 is formed to store the control data 60 received by the reading device 19. In further embodiments of the invention, the memory 22 may be controlled by the configurator 21 by means of configuration data 51 via a configuration data line, such that the channels to be stored can be configured. In an embodiment of the invention, the memory is formed as a RAM (Random Access Memory), preferably as a DRAM (Dynamic Random Access Memory) and as an SDR (Synchronous Dynamic RAM) or as a DDR (Double Data Rate Synchronous Dynamic RAM) device.

Control switch 26, reference switch 27 and test switch 28 preferably are formed as electronically switchable devices, which can be controlled by a control line by switching through the data present at the input or switching away the data present at the input.

The amplifier 23 preferably is realized as an active circuit of electronic devices and, in a form, consists in an operational amplifier embodied as integrated circuit of transistors, bipolar transistors, JFETs (Junction Field Effect Transistors) and MOSFETs (Metal Oxide Semiconductor Field Effect Transistors). Configurator 21, reference data reader 24 and test data reader 25 preferably are embodied as decoders. They decode those data of the data stream received from the wireless interface 20 to which same are addressed. The wireless interface 20 further preferably is embodied as a demultiplexer and distributes the data received at the wireless receiver according to a multiplexing protocol to the three lines 51, 52 and 53, which lead to the configurator 21, to the reference data reader 24 and to the test data reader 25, respectively. The configurator 21 converts the received configuration data 51 into control commands for the three switches and/or controls the amplification of the amplifier 23. In a preferred embodiment, it is formed as a discrete logic device, particularly as a semiconductor device or as an FPGA (Free Programmable Gate Array). Test data and reference data readers preferably also are formed as semiconductor devices.

Addition unit 55 and subtraction unit 54 preferably are formed as discrete semiconductor circuits with transistor logic.

By means of the configurator 20, the monitoring device can be placed into one of the three configurations of “recording mode”, “diagnostic mode” or “test mode”. The control of the respective mode takes place via the three switches “control switch 26”, “reference switch 27” and “test switch 28”.

In the recording mode, the control switch 26 is switched on, the reference switch 27 is switched off, and the test switch 28 is switched off. The control data 11 received at the input 17 from a first controllable lamp are stored in a memory 22 and read in reading means 19. The read control data 14 stored by means of the memory 22 reach a subtraction unit 54, which leaves same unchanged, however, since the reference switch 27 is open in the recording mode. The data 55 present at the output of the difference unit are supplied to a wireless interface 20 and wirelessly transmitted via an antenna 16. The wireless receiver may now record these data 15 in wireless fashion. Furthermore, the control data received at the input, after having passed an addition unit 55, which leaves same unchanged, since the test switch 28 is open in the recording mode, are amplified by an amplifier 23 and supplied to an output 18. The output passes the input control data amplified, if required, as output control data 12 on to a second programmable lamp.

So as to be able to operate the monitoring device for programmable lamps 10 in the diagnostic mode, the wireless interface 20 is formed to be able to receive reference data 52. The configurator 21 switches the control switch 26 on, the reference switch 27 on, and the test data switch 28 off. Hence, the control data 11 pass from a first programmable lamp via the input 17 to a memory 22, whereupon the reading means 19 may read the control data and may perform a target/actual comparison via a subtraction unit 54. The reference data 52 required for the target/actual comparison pass to the subtraction input of the subtraction unit 54 via the reference data reader 24 and the switched-on reference switch 27. There, the reference sequence 55 is calculated, which informs about deviations of the control data 11 present at the input from the desired reference data 52. The error sequence 55 may be interpreted as a DMX signal, from which the corresponding channel can be determined by reading the byte positions. The wireless interface 20 wirelessly transmits the error data 15, via an antenna 16, to the network technician on the ground, who therewith obtains exact information on error type and error location.

So as to be able to operate the monitoring device for programmable lamps in the test mode, the radio interface 20 is formed so as to be able to receive test data 53. For the test mode, the configurator 21 switches the control switch 26 to “off”, the reference switch 27 to “off”, and the test data switch 28 to “on”. The test data reader 25 reads the test data 53 present at the wireless interface 20 and switches same to an addition unit 55 via the switched-on test switch 28. Since the control switch 26 is switched off, the test data are directly passed on to the amplifier 23 and forwarded to the output 18. The test data 12 sent at the output finally pass to a second controllable lamp via the line. In this configuration, the monitoring device for programmable lamps can be used as a generator for feeding test data. Test data may, for example, be test data indicating a valid control sequence, for example “all lamps perpendicularly downward, red light on, dimmer off”. Test data may, however, also be data the downstream programmable lamps cannot interpret. In this case, the test data, for example, are solely used to test the line and indicate line parameters.

FIG. 3 shows a method of testing a programmable lamp 31 or a chain of programmable lamps.

A test generator 30 switches a test sequence to an addition unit 32. The addition unit 32 is upstream with respect to a programmable lamp 31, or in a chain of programmable lamps 31, or between a light panel and a programmable lamp. The addition unit 32 switches the test sequence to the input of the programmable lamp 31 or a chain of programmable lamps. The resulting output signal 35, which is present at the output of the path to be measured of the programmable lamp or the chain of programmable lamps, is passed on to evaluation logic 33, together with a copy of the test signal 34 present at the input of the path to be measured.

The test generator 30 generates a test sequence 34 for testing programmable lamps or the cabling thereof. The test sequence may, for example, be in form of white noise in which all frequencies are excited uniformly. The test sequence is fed into a programmable lamp 31 or a chain of programmable lamps via an addition unit 32. The signal 35 present at the output of the chain of programmable lamps is compared with a copy of the test sequence 34, as was fed into the programmable lamps. Power parameters and wrong or reverse polarity can be determined from both signals 35 and in evaluation logic 33. In particular, the power parameters of line attenuation, phase location, line termination, reflection attenuation as well as detection and localization of existing disturbances on the line can be determined. From the phase location, it may further be determined whether there is wrong polarity of the cables, and hence whether the cables have been attached incorrectly. Furthermore, it is possible to determine the site of the wrong polarity on the cable chain.

In a preferred embodiment, the test generator 30 is embodied as a signal generator, the evaluation logic 33 is embodied as a computer or as a digital circuit, which may be implemented on a network analysis device.

FIG. 4 shows a test method for a programmable lamp 31 or a chain of programmable lamps. A test sequence generator 40 switches the signals of a programmable lamp 31, of a light control panel 41 or a monitoring device for programmable lamps 10 to the input of a programmable lamp 31 or a chain of programmable lamps by means of switching logic 45 via an addition unit 32. The test signal is passed via the programmable lamp or the chain of programmable lamps and possibly changed if there is an error. The supplied signal or the changed supplied signal 44 is fed to evaluation logic 42. Furthermore, a copy of the supplied test sequence 43 is fed to evaluation logic 42. In the evaluation logic 42, the differential sequence is formed, the byte position within the differential sequence is associated with the corresponding control channel, and a potentially faulty channel is indicated.

The test sequence generator is embodied as a circuit of discrete logic in one embodiment of the invention and switches one of three input signals to the output, depending on the control of the circuit. The evaluation logic 42 is embodied as a computer or as a digital circuit, which may be implemented on a network analysis device.

FIG. 5 shows an embodiment of the invention. Three remotely controlled programmable lamps 31 are suspended from the ceiling and connected in series, wherein the third remotely controlled programmable lamp 31 is terminated with a terminating resistor 51. A light control panel 41 on the ground sends a DMX signal to the first programmable lamp 31. The first and second lamps 31 receive the correct data stream, there being a cable disturbance 50 between the second and the third lamp 31, which leads to a data problem and malfunction in the third lamp 31.

With the monitoring device 10 for programmable lamps according to the invention, the operator on the ground may have the control data at the location of the malfunction sent to him or her in extremely convenient way. A first monitoring device 10 is installed at the site of the malfunction, reads the control data 11, and sends a copy of the read control data 15 to the receiver on the ground, which is embodied as a second monitoring device 10, by means of a wireless interface. At the same time, the first monitoring device 10 passes the control data 11 received at the input on to the output as control data 12 in unchanged manner, so that control data are also present at the third controllable lamp 31 also during the test. At the same time, the first monitoring device 10 may receive configuration data 15 for self-configuration via the bi-directional wireless interface.

In preferred embodiments, the invention is based on the fact that control data for programmable lamps, which have color and direction information of the luminaire, are sent to the network technician on the ground in the programmable lamp. With this information, the network technician on the ground may check whether the control data at the location of the programmable lamp are correct or changed by wave reflections of the attached cables, wrongly attached cables, or defects in the devices. The network technician on the ground may avail himself or herself of the original sequence of control data transmitted, and may thus compare whether the control data sequence received from the programmable lamp via the monitoring device matches the original sequence. Upon a mismatch, he or she may determine the channel in which an error occurs, due to the byte position in the differential sequence.

The monitoring device may be attached at the target location of the programmable lamp by a specially trained rigger, and a network technician on the ground may control the control data received there. In the simplest case, the monitoring device only reads the control data and sends same to the operator on the ground via a wireless interface. The monitoring device then works in the recording mode. In this mode, the network technician on the ground obtains information on the control data sent and information on the control data received from the programmable lamp. He or she now must perform the comparison of the sent and received control data sequence by himself or herself to find the error. This error analysis may, however, also be executed directly by the monitoring device. It can be configured such that it is capable of receiving the reference data wirelessly, and of performing a target/actual comparison with the control data present at the input with these reference data. The monitoring device may determine the error automatically, identify the faulty channel by analysis of the error sequence, and send the information to the network technician on the ground. He or she no longer must search through all 512 bytes of the error signal received, since he or she receives information as to which channel has an error by means of a user-friendly display on the screen of the network analysis device.

The reference signal may originate directly from a light control panel, it may originate from a programmable lamp or from a second monitoring device for programmable lamps. For example, a reference signal can be generated such that a monitoring device for programmable lamps is attached directly downstream of a light control panel. In this configuration, it may be assumed that the control data do not yet comprise an error, since they are received directly from the light control panel. With a second monitoring device for programmable lamps at the end or in the middle of a chain of programmable lamps, diagnosis of the control signal can be performed. For example, the tester may play in defined test sequences, which signal the same behavior for all lamps, at the beginning of the chain, such as: “all lamps perpendicularly downward, red light on, dimmer off”. With the second monitoring device, diagnosis of the line may be performed, and the tester may check whether all programmable lamps behave similarly corresponding to the test sequence. On the other hand, he or she may perform a visual check from below.

The monitoring device may also be employed as a simple cable tester. To this end, it sends out a radio or wireless signal, which is supplied to the chain of programmable lamps. A second monitoring device in the middle or at the end of the line chain receives the wireless sequence supplied and compares same to a copy of the originally supplied signal. From input and output signals of the line, one may then determine line parameters, such as line attenuation, phase location, line termination, reflection attenuation, and detection and localization of existing disturbances on the line. From the phase location, a possible wrong polarity of the cable ends and its location may be inferred.

By sending the control data via a wireless interface to a network analysis device on the ground, the network analysis device no longer necessarily has to be built to be very compact, since it no longer has to be mounted below the ceiling by a rigger. It may, for example, be embodied as a notebook with a wireless interface and corresponding operating software. The transmitted monitoring data may be displayed in a user-friendly manner on a large display. It is no longer necessary to keep the network analysis device very compact for transportation requirement reasons. Instead, demands for user-friendliness and graphical representation can be dealt with. For example, status diagrams may be designed very clearly on a large notebook screen, and the analysis device may be operated very effectively by means of a mouse and keyboard. Libraries offering the tester access to the channel occupation and similar device-specific data may also be included. This new application could not be used so far, because the test devices had to be taken to the error location and therefore had to be built to be as lightweight as possible.

The monitoring device for programmable lamps does not have to be fabricated as an external device. In a particular embodiment of this invention, the monitoring device for programmable lamps may be directly integrated in a programmable lamp. If the monitoring device is directly integrated in the reception devices, the entire chain may be checked in contactless way from device to device until the error has been found. It is then no longer necessary to attach an externally built monitoring device at the location of the error, but the programmable lamps in which the monitoring function is integrated perform error diagnosis by themselves in software-aided manner. For example, the operator calls up a “data check” function on the network analysis device, which executes diagnosis of the entire network of programmable lamps and returns the status of the network including potential malfunctions with positional and type indication. It would also be possible to have the programmable lamps execute automatic monitoring in an initialization phase after the assembly, such that it can be signaled whether the programmable lamp is working flawlessly or whether an error in the form of a cable reflection, wrong cable polarity or a device defect is present, by means of an error LED on the programmable lamp.

With this, an external test device would no longer be necessary either.

Further embodiments of the present invention are set forth in the following:

One embodiment includes a tester for the serial data protocol, which sends its data to a receiver in form of a wristwatch by means of the same radio link. The device has a data input, a data output and the radio interface in a housing as robust and compact as possible. Previously, such testers were handheld devices provided with a display, which had to be used and operated at the respective location of the error source. With the variant according to the invention, it would be possible to have the tester attached at the data bus at the problem site by a person unafraid of heights. The analysis of the measured values may now be performed by a correspondingly trained technician from the ground.

In a further embodiment, the tester may send and receive data and also transmit and simultaneously read the received data. If several testers are operated with a watch (or other control device with the same functional features) in the radio network, e.g. a tester may be attached directly as a first device to the light control panel. This tester thus is likely to read error-free data. A second tester is included somewhere into the data line. The watch now receives data from both devices and can then make actual/target comparisons. Thereby, the device may indicate the error data directly to the technician. Troublesome comparison of the corresponding individual data by the user himself or herself is omitted.

Furthermore, the tester and a remotely controllable programmable lamp may also be used in combination.

Embodiments of the invention are also referred to as “wireless DMX testers”, in order to have a wirelessly controllable analysis device for data protocols common in stage event technology.

The presently most common, and unfortunately also most error-prone, one is DMX512. It is based on the RS 485 standard, which is why the interface devices developed therefore also may be used. 512 useful data of 8-bits width are transmitted. Handshaking is not provided. The transmitting device sends an exactly defined start sequence and a maximum of 512 bytes thereafter, with increasing channel numbers. Thereafter, the data packet starts again from the beginning. The receivers are only capable of receiving. Feedback to the transmitter does not take place. The receivers are assigned start addresses, beginning from which they read their required channel numbers in the data stream. Other data are ignored. The data cable is drawn through from one device to the next one (see first variant) and is also fitted with a terminating resistor against wave reflections at its end (after a maximum of 32 devices). More details are to be found on the Internet page “http://www.soundlight.de/techtips/dmx512/dmx512.htm”.

The problem occurring many times in practice is that there are wave reflections. The reasons may be a missing terminating resistor, bad/defective cables or scatterings from other cables/power supply units. Since the transmitter does not receive any feedback, this can only be recognized from the fact that devices suddenly no longer react correctly, even though everything seems to be in order. These errors may occur sporadically and migrate within the strand, whereby partly lengthy troubleshooting becomes necessary. To aggravate the situation, the devices are partly mounted on the ceiling or above a lake/swimming pool or the like.

One example in this respect makes clear a first variant: three devices (Moving Heads) here are suspended from the ceiling and connected in series, wherein the third device is terminated with a terminating resistor. A transmission panel on the ground sends the DMX signal to the first device. The first and second devices receive the correct data stream. In the third device, there is a data problem that makes itself noticeable by malfunction. Troubleshooting is not possible on the ground, however.

In such a case, the procedure is according to a second variant: a technician must undo the data connection with a hand-held analysis device on location (in this case on the ladder) and can then read the values of the data packets on the display of the tester. Most test devices do not forward the useful signal. This means that the error may not be recognizable at all during the test procedure. Since the operator at the light control device (but usually not the man on the ladder) knows the correct data, communication now has to take place between the man with the test device and the man on the ground. This either requires a radiotelephony connection or a short distance between the two (for communication by shouting) or corresponding hand signs. Moreover, the man on the ladder must both be unafraid of heights and be familiar with the analysis device and with the potentially occurring errors. It is possible, however, that the network technicians are not able to climb around below the ceiling, and those capable of that (so-called “riggers”) are not able to perform error analysis.

In such a case, by means of a third variant, a long cable (test cable) may be attached at the error site and guided back to the ground. Now, the operator of the light control device himself or herself may check whether the arriving data correspond to the data sent. However, this comparison still has to be made “manually” in the analysis devices common on the market, by reading and comparing, that is. A further problem consists in the fact that the long cable attached additionally completely changes the wave resistance of the chain and the error may no longer occur thereby. Moreover, by attaching the test cable, the line between the second and the third device is undone, so that the third device does not receive any data during the test. Remedy is provided by the “wireless tester”, which represents an embodiment of the invention. The device basically consists of a DMX output, a DMX input and a radio interface. Since the device has the radio interface, which ideally functions with equal data packets, like the remotely controlled programmable lamp, no display is required on the device, but only the watch of the remotely controlled programmable lamp for operating.

Now, various functions may be utilized:

1. The tester has been included into the chain at the error site (fourth variant, see also FIG. 5). The device reads the data and sends the received data on to the following receivers. Here, data are also present at the input of the third device during the test. The read data are now sent to the watch of the operator on the ground, who can control same. Attaching the tester first may be done by a rigger, and the network technician then controls the data (yet still “manually”). A further advantage: in this case, the tester functions as a “booster”. That means it amplifies the signal, whereas input and output are simply connected in “normal receivers”. This means that corresponding attenuation of the signal takes place at the plugs in normal receivers. It may be that the signal amplification by the tester already has a positive effect.

2. Two test devices are employed: one at the beginning of the chain and one at the error location. Since the remotely controlled devices have a multiplicity of various functions mostly activatable simultaneously, it is partly difficult to even recognize at all whether there is a malfunction, and if so, which one. Defined test sequences (e.g. “all devices perpendicularly downward, red light, dimmer on”) may be played in at the input of the chain with the tester. On the one hand, visual control may take place, and data control by a second tester on the other hand. Certainly, this is also possible without such functions. One must always bear in mind that, prior to events, a lot of problems usually have to be solved in a minimum period of time, and test setups (and be it only the line cable from the third variant lying across the stage unprotected) may lead to accidents or delays in the assembly. For this reason, all improvements simplifying, and particularly capable of accelerating, troubleshooting are highly valuable.

3. A cable tester: The first tester sends a test signal not necessarily to be recognized by the reception devices. It only serves the second tester for testing the cable connection. In this way, e.g. the attenuation may be measured, or the phase location determined. Phase problems tend to occur in the case of cables with wrong polarity, which occurs more frequently than one may think it does.

4. The tester at the beginning of the chain is supplied with the data stream from the control device and then forwards same to the receivers. It may quite certainly be assumed that the data at this location are still in order. The second tester is at the error site. Both testers read the data. The testers communicate with each other via radio. This enables the first tester to perform an actual/target comparison between its supplied data and the data returned from the second tester. Now, the operator may read the pure error data, which have already been corrected for the “good” data. This offers significantly more overview than having to search through all 512 bytes.

5. Since both testers ideally do not have any operating part, and a very display does not necessarily contribute to convenience, the following would also be possible: configuration like in point 4. Tester 1 communicates with a notebook, which has a corresponding plug-in card, via a second radio channel. Now the parameters/read data/settings may be managed in extremely convenient manner, since they can be represented very clearly on the comparably large notebook display and operation by means of a mouse/keyboard is very effective as well. Thereby, also libraries may be included, offering the tester access to channel occupation and similar device-specific data. This possibility could not be used until now since the test devices had to be taken to the error location, and hence were built to be as compact as possible, which also had effects on the key number and display size.

6. It is a problem of all previously mentioned variants that the error location first has to be found by “trial and error”. The location at which the malfunction occurs and the location at which it develops do not always have to lie closely together. But if the analysis device is integrated into the reception devices (which is the case with all devices having the remotely controlled programmable lamp integrated), the chain may be checked in contactless way device by device until the error has been found. In this case, this procedure may even take place automatically in software-aided manner. This means that the operator calls up the “data check” function and is provided with an error location and error type by the wireless network—either to the watch or the notebook, depending on the configuration.

In summary, in the previous sections it has been explained how a tester is introduced at certain locations to test these really transmitted data. Moreover, it has been shown how a tester is to be attached to the data bus at the problem site (by a person unafraid of heights), or what this tester, once it somehow is connected to the data bus, for example via a T part, then does, or what data it extracts and wirelessly transmits to the test receiver. It has been explained what is to be understood by the fact that a tester “passes data through and simultaneously reads same”. The difference between a attached tester and a tester attached at some location to be measured in the radio field has been explained. The present invention in its “tester application” does not necessarily exclusively relate to the remotely controlled programmable lamp, but also to the prior patent application 102004007057.1, wherein it already was described that control data can be transmitted via radio or via power line modulation. For these applications, the tester could be placed in front of the modulator or also behind the modulator, and it would also be possible for the tester to have a modulator-demodulator of its own here. Furthermore, automatic comparison was performed in the invention in that the data are measured by a “tester” in their correct state directly at the light control panel, and that the data are then measured somewhere in the data line. It has been shown here that a second tester is to be “incorporated”, which means that the tester in a way receives the data transmitted via the serial line, taps same and sends same out in wireless or wired way, such that an actual/target comparison with the clean data and the potentially noisy data then is performed.

Furthermore, synergy effects have been pointed out as to why an actual/target comparison for a special data protocol and/or for the lamp control has a particular advantage as compared with other actual/target comparisons common in normal tests. Finally, “interesting combinations” with the remotely controlled programmable lamp according to this invention have been mentioned.

Embodiments with a detailed protocol have been set forth, and clarification of the term “actual/target comparison” has been set forth, offering sufficient disclosure of the procedure according to the invention.

In the preferred embodiment, the monitoring device is not only used for monitoring the programmable lamps but is also implemented to perform active tasks. To this end, the interface 20 of the monitoring device which can be a wireless interface, but can alternatively also be an interface for a wired network such as a local area network. One local area network is the well-known Ethernet. Over this local area network, the DMX control signals can also be transmitted. Implementations of this technology are known and described within the ARTNET protocol.

Based on the wireless interface or the local area network interface, the monitoring device can receive and input controls for performing error recognition actions. In case an error has been detected, a command can be received from the monitoring device via the interface from a controller and input into a programmable lamp in order to check the reaction, and then to determine, based on the reaction, where the detected error could be located or in which logical functionality the error could reside.

The specific implementation would be for the monitoring device, to receive specific defined test packets over the interface, and the monitoring device would then feed the defined test packet either to the first programmable lamp connected to the input or to the second controllable lamp connected to the output.

For the purpose of detecting any errors, the monitoring device could also be adapted to switch on different terminating resistors at the last programmable lamp such as 31 (FIG. 3) in the chain of programmable lamps. It has been found that, often, the transmission line resistance of the control line is different from the specified transmission line resistance. Therefore, the terminating resistors at the last programmable lamp, although they have the specified value, are not suitable for generating a transmission line termination with low or no reflection.

Therefore, by switching off specified terminating resistors and by switching on terminating resistors having different values, or by varying the resistance value of a terminating resistor, several tries can be made to find out whether the error disappears, when the terminating resistor is controlled to have a different resistor value. Such an action performed by the monitoring device in reply to a detected error or the detected unusual situation is an example for a repair measure. Therefore, the inventive monitoring device preferably performs repair measures as well.

Depending on specific implementations, the monitoring device can also be positioned near or event integrated into the last programmable lamp. In this implementation, the monitoring device will only have an input for receiving control data from the first controllable lamp, but will not have a separate output, compared to a situation in which the monitoring device is positioned between two controllable lamps.

As indicated in FIG. 5, the receiver 10 communicating with the monitoring device 10 connected to one or more programmable lamps can be implemented as a separate mobile device or can, alternatively, be integrated into the light controller 41. This device 10 which can either be integrated into the controller or can be a separate mobile device will control the monitoring device 10 connected to one or more programmable lamps and will be implemented to additionally transmit the error detection and error identification commands and, additionally, instructions for performing repair measures, such as controlling the last programmable lamp in order to set different termination resistance values.

Depending on the circumstances, the method according to the invention may be implemented in hardware or in software. The implementation may be done on a digital storage medium, particularly a floppy disc or a CD, with electronically readable control signals capable of cooperating with a programmable computer system so that the corresponding method is executed.

In general, the invention thus also consists in a computer program product with a program code stored on a machine-readable carrier for performing the method according to the invention, when the computer program product is executed on a computer. In other words, the invention may thus be realized as a computer program with a program code for performing the method, when the computer program is executed on a computer.

1. Monitoring device for programmable lamps (10), comprising:
an input (17) for receiving control data (11) from a first controllable lamp;
an output (18) for forwarding the control data (12) to a second controllable lamp;
reading means (19) for reading the control data (13) received from the input; and
an interface (20) for transmitting the control data (14) read from the reading means or data derived from the read control data.

2. Monitoring device for programmable lamps according to claim 1,
wherein the interface (20) is formed to receive configuration data (51), and wherein the input (17), the output (18) or the reading means (19) or the wireless interface (20) are formed to be configured by the configuration data (51).

3. Monitoring device according to claim 1 or 2, wherein the input for receiving control data (17) is an interface for a control cable or an interface for a supply line onto which the control data are modulated, or wherein the output for forwarding the control data (18) is an interface for a control cable or an interface for a supply line onto which the control data are modulated, or wherein the interface (20) for transmitting the control data (14) is a wireless interface.

4. Monitoring device according to one of the preceding claims, comprising:
an amplifier (23) for amplifying the control data (11) received at the input (17), with amplification coupled to the output (18).

5. Monitoring device according to one of the preceding claims, wherein the control data (11) are formatted and treated in accordance with a serial data transmission protocol.

6. Monitoring device according to one of the preceding claims, wherein the data transmission protocol is a DMX protocol.

7. Monitoring device according to one of the preceding claims, comprising:
a memory (22) for storing at least the control data (13) received at the input.

8. Monitoring device according to one of the preceding claims, wherein the interface (20) is separate from the input (17) and from the output (18).

9. Monitoring device according to claim 2, wherein the interface (20) is formed to receive reference data (52), and wherein a subtraction stage (54) is formed to generate data derived from the control data read by means of the reading means (19) and the reference data (52) from the interface (20).

10. Monitoring device according to claim 2, wherein the interface (20) is formed to receive test data (53), and wherein the output (18) is formed to forward the test data to a second controllable lamp.

11. Monitoring device according to claim 9, comprising:
a reference data reader (24) for reading the reference data (52) received from the interface (20);
a reference switch (27) for switching on or off the reference data (52) read by the reference data reader (24);
a subtraction stage (54) for subtracting the reference data (61) switched by the reference switch (27) from the control data (14) read by the reading means (19) and stored in the memory (22).

12. Monitoring device according to claim 10, comprising:
a test data reader (25) for reading the test data (53) received from the interface (20);
a control switch (26) for switching on or off the control data (13) read from the input (17);
a test switch (28) for switching on or off the test data (66) read by the test data reader (25);
an addition stage (55) for adding the control data (62) switched by the control switch (26) and the test data (64) switched by the test switch (28).

13. Monitoring device according to claims 2 to 12, comprising:
a configurator (21) formed to place the monitoring device (10) into the recording mode by means of configuration data (51) received via the interface (20), comprising:
reference switch (27) and test switch (28) are switched off, control switch (26) is switched on.

14. Monitoring device according to claim 13, comprising:
the configurator (21) being formed to place the monitoring device into the diagnostic mode by means of configuration data (51) received via the interface (20), comprising:
control switch (26) and reference switch (27) are switched on, test switch (28) is switched off.

15. Monitoring device according to claim 13, comprising:
the configurator (21) being formed to place the monitoring device into the test mode by means of configuration data (51) received via the interface (20), comprising:
control switch (26) and reference switch (27) are switched off, test switch (28) is switched on.

16. Monitoring device according to claims 13, 14 and 15, comprising:
the configurator (21) being formed to arbitrarily switch the control switch (26), reference switch (27) or test switch (28) on or off by means of configuration data (51) received via the interface (20).

17. Monitoring device according to claims 13, 14 and 15 and according to claim 4, comprising:
the configurator (21) being formed to adjust the amplifier (23) according to claim 4 in its amplification by means of configuration data (51) received via the interface (20).

18. Monitoring device according to one of the preceding claims, further comprising:
fastening means for fastening the monitoring device (10) to a wall, to a pillar or to a ceiling of a room or to a programmable lamp.

19. Monitoring device according to one of the preceding claims, comprising:
a power supply input of its own, which is formed to be supplied with current via an external power supply unit, or an accumulator formed to supply the reading device.

20. Monitoring device according to one of the preceding claims, comprising:
the input (17) including an XLR plug or socket;
the output (18) including an XLR plug or socket.

21. Monitoring device for programmable lamps (10), comprising:
an input (17) for receiving control data (11) from a controllable lamp, which is the last lamp in a chain of programmable lamps;
reading means (19) for reading the control data (13) received from the input; and
an interface (20) for transmitting the control data (14) read from the reading means or data derived from the read control data, wherein the interface is operative to receive an error counter measure signal from a control device, and wherein the monitoring device is operative to apply the error counter measure.

22. Method of monitoring a programmable lamp, comprising:
receiving control data of a first lamp;
forwarding the control data to a second lamp;
reading the control data;
transmitting the control data or data derived from the control data.

23. Method of claim 22, further comprising:
defining of a check or test sequence;
supplying the predefined check or test sequence to a programmable lamp or a chain of programmable lamps;
receiving the supplied check or test sequence;
comparing the received check or test sequence with a copy of the check or test sequence supplied.

24. Method according to claim 23, comprising:
defining of the check or test sequence ideally as white noise;
determining line parameters from the received check or test sequence and a copy of the check or test sequence supplied;
determining particularly line attenuation, phase location, line termination, reflection attenuation, and detection and localization of existing disturbances on the line.

25. Method according to claim 24, comprising:
determining a wrong polarity of the cables or the cable chain from the phase location;
determining the location of the wrong polarity.

26. Method according to claim 23, comprising:
definition of the test sequence as control data from a light panel or a programmable lamp or a monitoring device for programmable lamps;
localization of a malfunction by association of the byte position of the differential sequence of received test sequence and copy of the supplied test sequence with the corresponding channel.

27. Method according to any of claims 22 to 26, further comprising:
receiving an error counter measure instruction via an interface (20), applying an error countermeasure to a controllable lamp; and
checking whether the error countermeasure was successful and an erroneous performance of a controllable lamp was refused or eliminated.

28. Method in accordance with claim 27,
in which the error countermeasure is a setting of a different terminating resistor,
wherein the terminating resistor is located in the last programmable lamp in a chain of programmable lamps or is connected to a data output of the last programmable lamp in a chain of programmable lamps.

29. Programmable lamp with a housing, wherein a monitoring device for programmable lamps in accordance with any one of the claims 1 to 21 is accommodated in the programmable lamp housing.

30. Computer program with a program code for performing the method according to claim 22, when the computer program is executed on a computer.
